(19) United States
(12) Patent Application Publication
(10) Pub. No.: US 2015/0021841 A1
(43) Pub. Date: Jan. 22, 2015

(54) BEAM-SUPPORTED JOINING MACHINE, IN PARTICULAR LASER TRANSMISSION WELDING DEVICE

(71) Applicant: LPKF LASER & ELECTRONICS AG, Garbsen (DE)

(72) Inventors: Thomas Amann, Deuerling (DE); Matthias Lippl, Regensburg (DE); Anton Schmailzl, Regensburg (DE)

(73) Assignee: LPKF LASER & ELECTRONICS AG, Garbsen (DE)

(21) Appl. No.: 14/383,647

(22) PCT Filed: Feb. 28, 2013
(86) PCT No.: PCT/EP2013/053991

§ 371 Date: Sep. 8, 2014

(30) Foreign Application Priority Data
Mar. 8, 2012 (DE) 10 2012 203 694.6

(51) Int. Cl. B25B 11/00

(52) U.S. Cl. CPC B25B 11/002
USPC 269/8

(57) ABSTRACT

A beam-supported joining machine, in particular laser transmission welding device, including a beam head for providing a joining beam producing a joining seam between two components, a receiver for mounting the first component, and a clamping mechanism for clamping the components, in particular to clamp components with a joining seam running three-dimensionally. The clamping mechanism has a clamping device adapted to the course of the joining seam to produce a clamping force between the two components at least in the region of the respective joining zone acted upon by the joining beam, wherein a magnetic or magnetisable strip adapted to the course of the joining seam is provided as the clamping device, which strip, at least in the region of the respective joining zone acted upon by the joining beam, applies a clamping force to the components by a control magnet guided with the joining beam due to the magnetic forces acting between the strip and control magnet.

### CROSS-REFERENCES TO RELATED APPLICATIONS

This application claims the priority of German Patent Application, Serial No. 10 2012 203 694.6, filed Mar. 8, 2012, pursuant to 35 U.S.C. 119(a)-(d), the content of which is incorporated herein by reference in its entirety as if fully set forth herein.

### FIELD OF THE INVENTION

The invention relates to a beam-supported joining machine and, in particular, a laser transmission welding device, comprising
a beam head for providing a joining beam producing a joining seam between two components,
a receiver for mounting the first component, and
a clamping mechanism for clamping the components, in particular to clamp components with a joining seam running three-dimensionally, which clamping mechanism has a clamping means adapted to the course of the joining seam to produce a clamping force between the two components at least in the region of the respective joining zone acted upon by the joining beam.

### BACKGROUND OF THE INVENTION

Joining machines of this type can also be realised by laser butt welding systems, laser soldering systems or the like in addition to the laser transmission welding device mentioned. As is known, for example, from DE 10 2007 042 739 A1, beam-supported joining machines of this type have a beam head for providing a joining beam producing the joining seam between the two components, a receiver for mounting a first component and a clamping mechanism for clamping the two components. In the clamping mechanism according to the aforementioned document, an internal clamping punch is provided, which introduces the clamping force into the surface surrounded by the weld seam. Another embodiment of this clamping mechanism is based on thin webs, which mechanically connect an external clamping frame to the internal clamping punch. An adequate gap is produced here between the external and internal clamping technology to form the weld seam.

This type of clamping mechanism is problematical for a three-dimensionally running joining seam as the frame-like internal clamping jaw or the individual clamping jaws engaging from the outside in are very complex with regard to their mounting and construction. The drawback in the use of the punch clamping technology described above in combination with the contour welding method is furthermore the comparatively poor ability to bridge the gap. This occurs in that the clamping punch has contact with the component over the entire area but the material is only plasticised at points.

DE 101 33 956 A1 discloses a clamping mechanism for laser soldering or laser welding, in which a geometry clamping means, so-called there, is provided, which has a form adapted to the contour of the respective structural element. The structural element is placed against a surface of the form in a non-positive and flat manner by a negative pressure, which is produced, in particular, by to a large number of individual suction cups. The disclosed clamping mechanism is also very complex here and problematical during the clamping of components with a joining seam running three-dimensionally due to the suction cups used.

DE 100 60 394 A1 discloses a mechanism for fixing components to be welded by means of a laser. In this case, the clamping jaws are manufactured from a material that transmits the laser beam.

### SUMMARY OF THE INVENTION

The invention is now based on an object of improving a beam-supported joining machine with respect to its clamping mechanism for clamping the components in such a way that a high clamping force can be applied to the components in a particularly effective manner even with a joining seam with a complex course.

This object is conceptionally achieved by a magnetic or magnetisable strip adapted to the course of the joining seam being provided as the clamping means, which strip, at least in the region of the respective joining zone acted upon by the joining beam, applies a clamping force to the components by means of a control magnet guided with the joining beam which clamping force is due to the magnetic forces acting between the strip and control magnet.

Accordingly, provided in the clamping frame of the clamping mechanism is a magnetic or magnetisable strip adapted to the course of the joining seam, which strip, at least in the region of the respective joining zone acted upon by the joining beam, applies a clamping force to the components by cooperation with a control magnet guided with the joining beam which clamping force is due to the magnetic forces acting between the strip and control magnet.

The clamping principle according to the invention, in a departure from previously known clamping principles, utilises magnetic forces to produce the clamping between the components to be connected. In particular when magnetic repulsive forces are used for clamping, these can be transmitted contactlessly to the components. An adaptation to a complex course of the joining seam is possible, in a structurally simple manner here, owing to the magnetic or magnetisable strip provided—only a magnetic strip will be referred to below. To this extent, complex seam geometries can also be joined with the aid of the clamping mechanism according to the invention.

According to a preferred embodiment, the magnetic strip is formed by a large number of permanent magnets arranged in a row next to one another, which, with the polarity in the same direction, face the control magnet and therefore also the components to be acted upon. The installation direction is preferably such that the magnetic repulsive force mentioned above is produced between the control magnet and the permanent magnet as a clamping force for the components to be clamped.

According to a further preferred embodiment, the magnetic strip has a ferromagnetic strip insert that is continuous in the longitudinal direction of the strip to hold the permanent magnets. Due to the attractive force between this ferromagnetic strip insert and the permanent magnets, an assembly which is uniformly manageable during the assembly of the clamping mechanism is provided. Because of the segmented permanent magnets, a flexible form adaptation of the magnetic strip is possible here, which makes this type of clamping device suitable particularly for joining seams running three-dimensionally.

The control magnet is preferably a solenoid guided with the beam head. The latter may also be fastened to the beam head so that the clamping force due to the magnet between the components is produced synchronously with the movement of the beam head without further measures. The clamping force between the two components is thus advantageously produced where it is required for the successful welding of the two components.

In a further preferred embodiment, the clamping frame with the magnetic strip can be provided simultaneously as a handling device for the second component to be placed on the first component. The degree of integration is thus increased in the joining machine according to the invention.

A preferred configuration of this integration provides that the handling device has a carrier plate, which is adapted to the shape of the second component and which at least temporarily holds this second component for handling and in the edge region of which is arranged the magnetic strip. This carrier plate is thus, on the one hand, used as a manipulation means for the component to be held and, on the other hand, it receives the magnetic strip. The carrier plate therefore fulfils an advantageous double function.

With regard to components, which are typically to be joined with the aid of laser transmission welding, which are, for example, vehicle rear light covers, a particularly efficient type of fastening of these components to the carrier plate is defined by means of negative pressure loading. For this purpose, the carrier plate can preferably be configured as a semi-flexible mat, in particular a silicone mat. “Semi-flexible” is to be taken to mean here a rubber-elastic configuration in the manner of a suction cup, whereby the carrier plate can, without problems, closely fit a surface, which is three-dimensionally formed with gentle rounded areas, of the component to be held and a reliable suction behaviour can therefore be achieved.

According to a further preferred embodiment, the carrier plate is provided with a preferably closable suction valve, by means of which negative pressure can be applied to the separating plane between the carrier plate and the component to be held. The component can thus be held on the carrier plate by intermittent connection of a negative pressure supply to the suction valve, it being possible to separate the negative pressure source from the closed suction valve to handle the component. Nevertheless, the component continues to adhere to the carrier plate due to negative pressure and can be manoeuvred into its desired position on the first component.

The suction valve can finally be given an advantageous double function if it simultaneously acts as a docking element for the handling device of the joining machine. The handling device may, for example, be a manipulator arm of a multi-axle handling robot. The entire handling process for the component can then be controlled with the aid of the carrier plate and the docking element attached thereon in the form of the suction valve.

A further system simplification is produced by the preferred development that the beam head and the handling device are guided on a common manipulator arm. The placing of the second component, which is to be welded to the first component, the clamping thereof with the aid of the magnetic clamping device, the simultaneous production of the joining seam by welding the two components with a reliable clamping force in the region of the joining zone and the removal of the product consisting of the two welded components from the receiver can be carried out here by means of the manipulator arm, which engages on the docking element representing the suction valve on the carrier plate, without further technical system requirements.

Further features, details and advantages of the invention emerge from the following description of an embodiment with the aid of the accompanying drawings.

### BRIEF DESCRIPTION OF THE DRAWINGS

FIG. 1 shows a perspective view of a laser transmission welding device,

FIG. 2 shows a perspective, enlarged detailed view of the welding device according to FIG. 1,

FIG. 3 shows a section of the welding device according to FIGS. 1 and 2 in the joining zone, and

FIGS. 4 to 7 show views of the laser transmission welding device according to FIG. 1 in consecutive intermediate manufacturing steps.

### DESCRIPTION OF THE PREFERRED EMBODIMENT

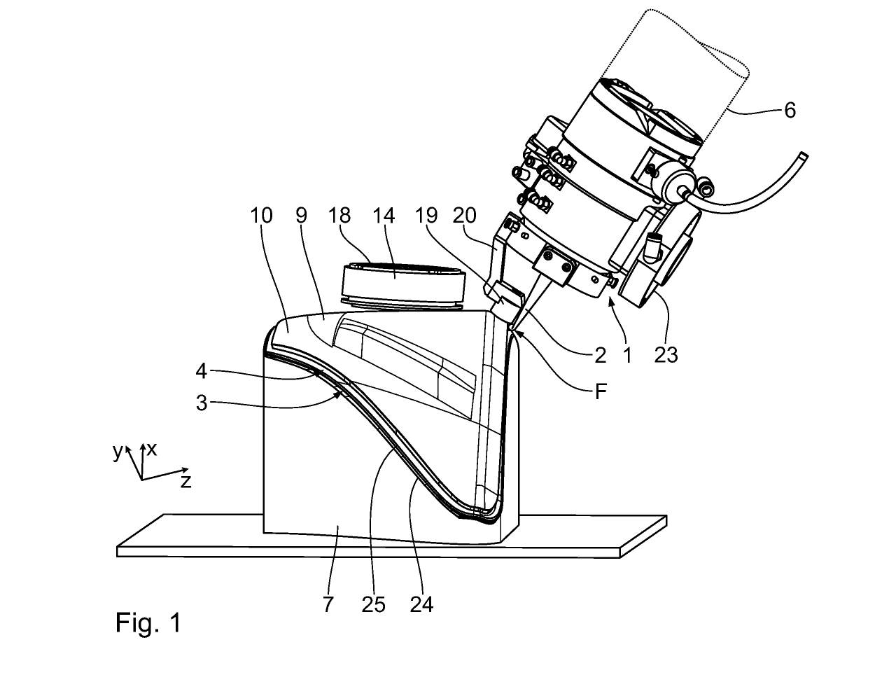

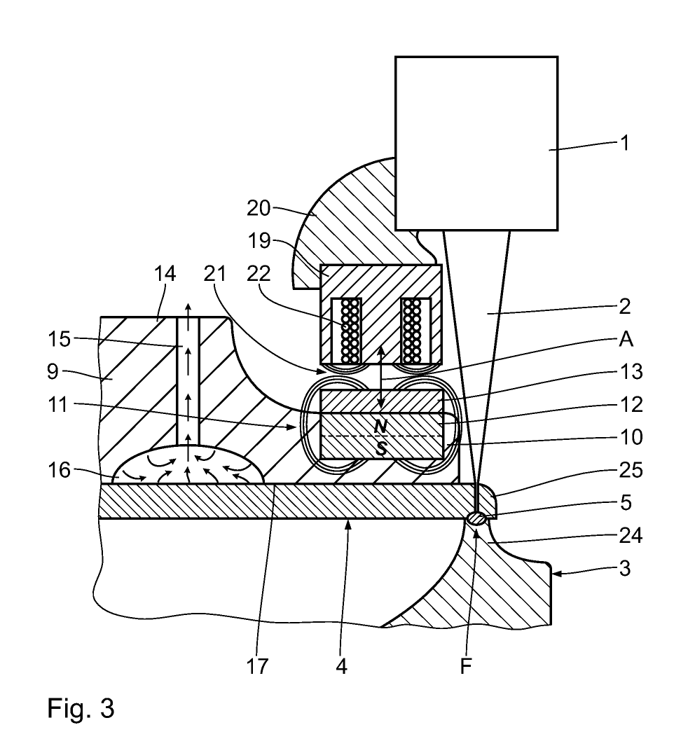

As can be seen from FIGS. 1 to 3, a laser transmission welding device has a beam head 1, with the aid of which a laser beam 2 guided from a laser source, not shown, is focused on the components 3, 4 to be joined and is guided along the weld seam 5 to be produced by means of a manipulator arm 6, indicated schematically in FIGS. 1 and 3, of a handling robot. The beam head 1 itself is of a conventional design with respect to its optical configuration and therefore does not need to be described in more detail.

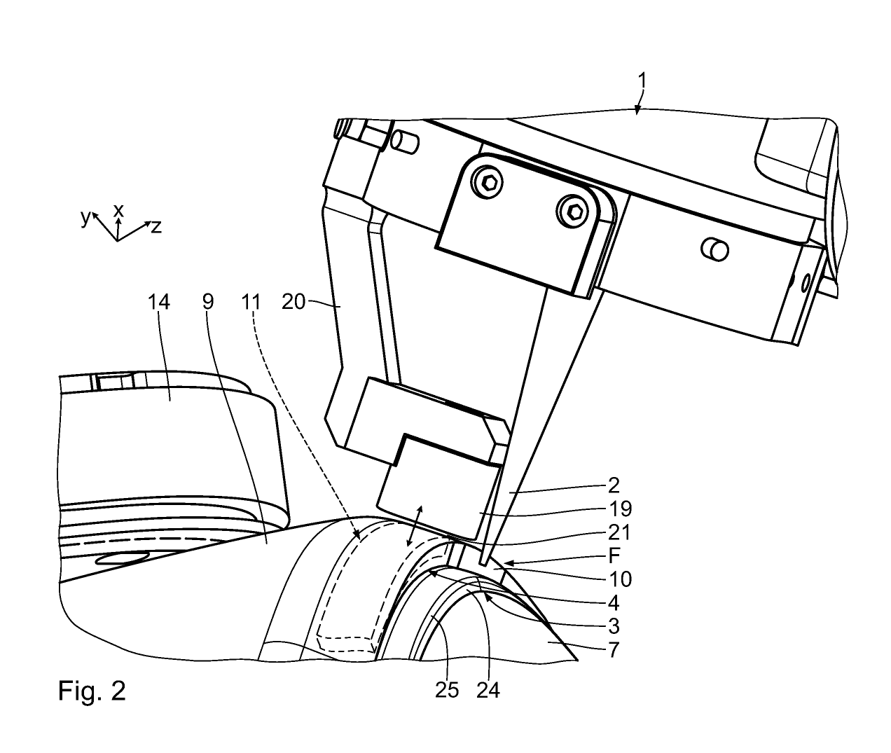

Of the two components 3, 4, only an edge region can be seen in FIGS. 1 and 2 and this is, for example, a trough-like lamp housing as the lower component 4, on which a transparent, coloured covering disc is placed as the upper component 4 and is connected thereto all around along the weld seam 5 by known laser transmission welding. The lower component 3 is inserted precisely in position in a receiver 7. The upper component 4 is handled with the aid of a handling device, designated 8 as a whole, during the production process. For this purpose, the handling device 8 has a carrier plate 9 adapted to the three-dimensionally configured shape of the upper component 4 in the form of a mat consisting of semi-flexible, rubber-like silicone.

A magnetic strip 11, which consists of individual permanent magnets 12 arranged in a row next to one another along the edge 10, is integrated into the carrier plate, inwardly offset by a few millimetres, along the edge 10 of the carrier plate 9. These permanent magnets are all arranged with their magnetic poles N/S pointing in the same direction, in other words—for example as shown in FIG. 3—with their north poles N at the top. A strip insert 13 that is continuous in the longitudinal direction of the strip and made of a ferromagnetic material, such as a suitable steel, is inserted on the magnetic strip 11, said material forming, with the individual permanent magnets 12, a uniform assembly with the carrier plate 9.

As furthermore becomes clear from FIGS. 1 to 3, the carrier plate 9 is provided approximately centrally on its upper side with a suction valve 14, which can be docked to a negative pressure line in a manner not shown in more detail. Furthermore, the suction valve 14 is connected to a suction line 15 in the carrier plate 9, which leads to a negative pressure space 16 on the lower side 17 of the carrier plate 9 facing the component 4. Negative pressure can thus be applied to the separating plane between the carrier plate 9 and the component 4, so this component 4 can be permanently fixed to the carrier plate 9.

The suction valve 14 is furthermore provided with a mechanical coupling 18, with which it can be docked to the side of the of the beam head 1 on a corresponding docking mechanism 23, to manoeuvre the carrier plate 9 with or without component 4.

FIGS. 1 to 3 furthermore show a control magnet 19 in the form of a solenoid, which is fastened by means of an extension arm 20 to the beam head 1. The control magnet 19 is positioned in such a way here that it can be guided along the carrier plate 9 with a small air gap 21 above the assembly of the magnetic strip 11 and strip insert 13. With a corresponding activation of the coil 22, shown in FIG. 3, of the control magnet 19, a magnetic repulsive force A can be produced between the control magnet 19 and the permanent magnets 12 of the magnetic strip 11, which applies a corresponding clamping force to the upper component 4 and presses it against the lower component 3. This repulsive force is applied synchronously with the irradiation of the laser beam 2 on the lower component 3 absorbing the laser radiation through the upper, laser-transmitting component 4, so this typical laser transmission welding takes place under a high clamping force in the joining zone F surrounding the laser beam 2.

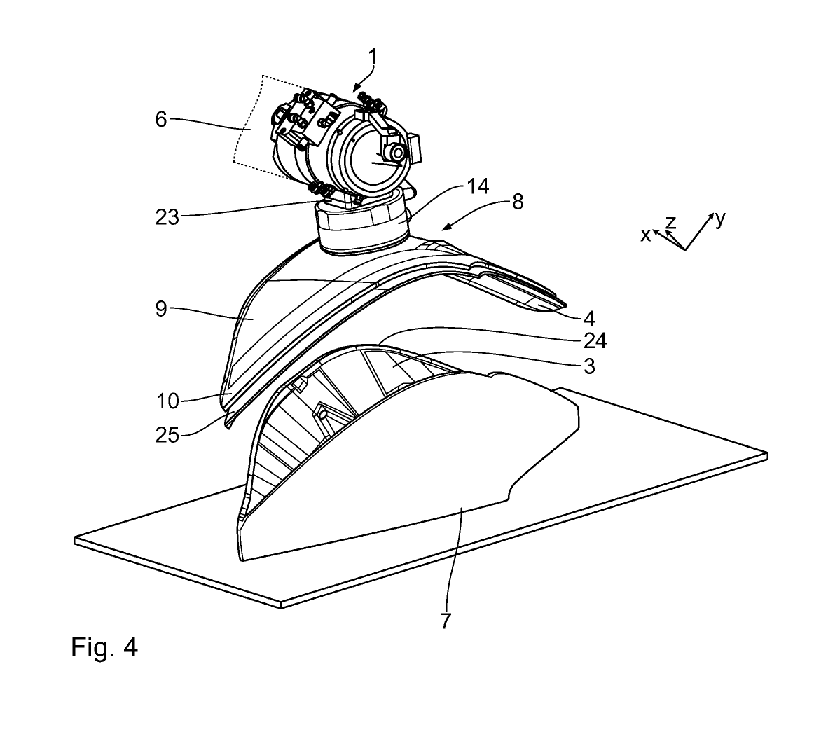

The welding process of the two components 3, 4 is now to be described with the aid of FIGS. 4 to 7.

Thus FIG. 4, on the one hand, shows the lower component 3, which is inserted in the receiver 7, to the three-dimensionally formed edge 24 of which component the correspondingly formed edge 25 of the upper component 4 is to be welded by means of laser transmission welding. The upper component 4 is manoeuvred here in that the beam head 1 is docked to the coupling 18 of the suction valve 14 of the carrier plate 9 with its lateral docking movement 23. The carrier plate 9 is moved to a corresponding supply magazine that provides the upper component 4. The carrier plate 9 is placed on this component and negative pressure is applied by means of the suction valve 14. The component 4 can thus be transported in the direction of the component 3 in the receiver 7. FIG. 4 shows this transporting step.

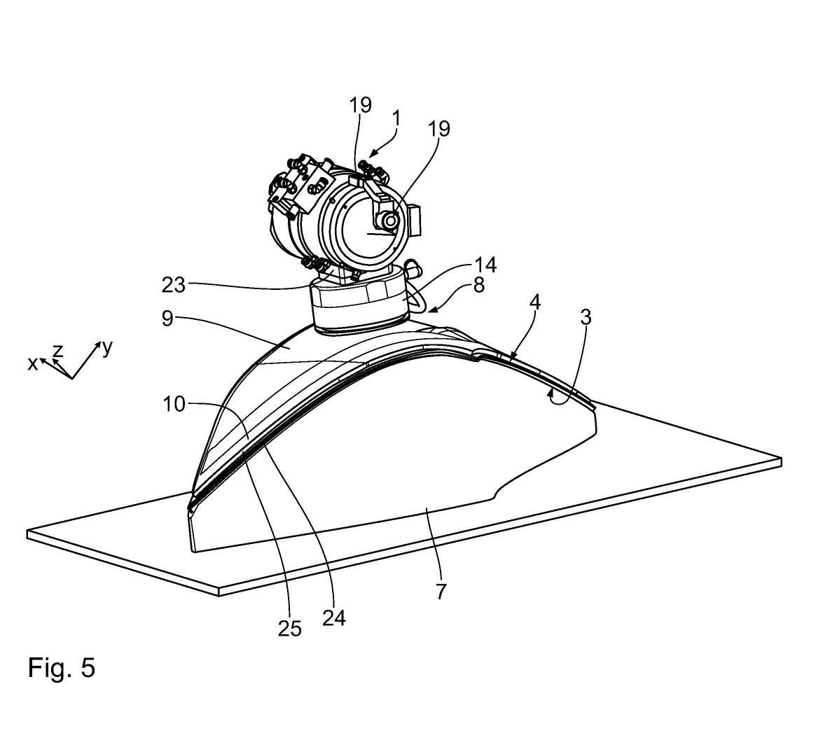

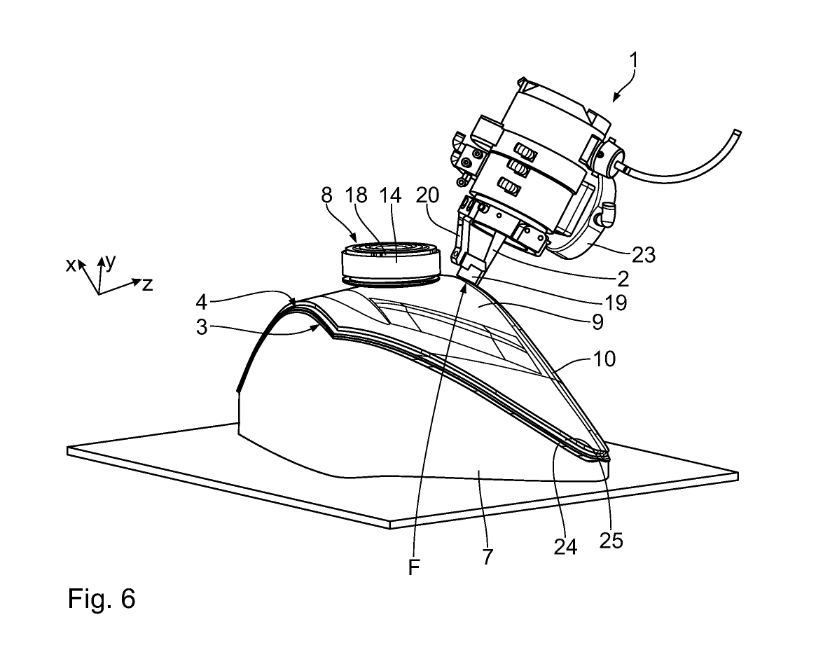

In FIG. 5, the carrier plate 9 is placed with the component 4 on the lower component 3 in the receiver 7. In this position, the suction valve 14 is closed, so the negative pressure between the carrier plate 9 and the upper component 4 is maintained and the latter is held on the carrier plate 9. The beam head 1 undocks from the suction valve 14 and then travels on the overlapping edges 24, 25 of the two components 3, 4 along their three-dimensional contours, the laser beam 2 producing the weld seam 5 shown in FIG. 3 along the peripheral edges 24, 25. By means of the control magnet 19 running in parallel synchronously therewith, the clamping force is applied during this welding process between the components 3, 4 in accordance with the magnetic repulsive force A—see FIG. 6.

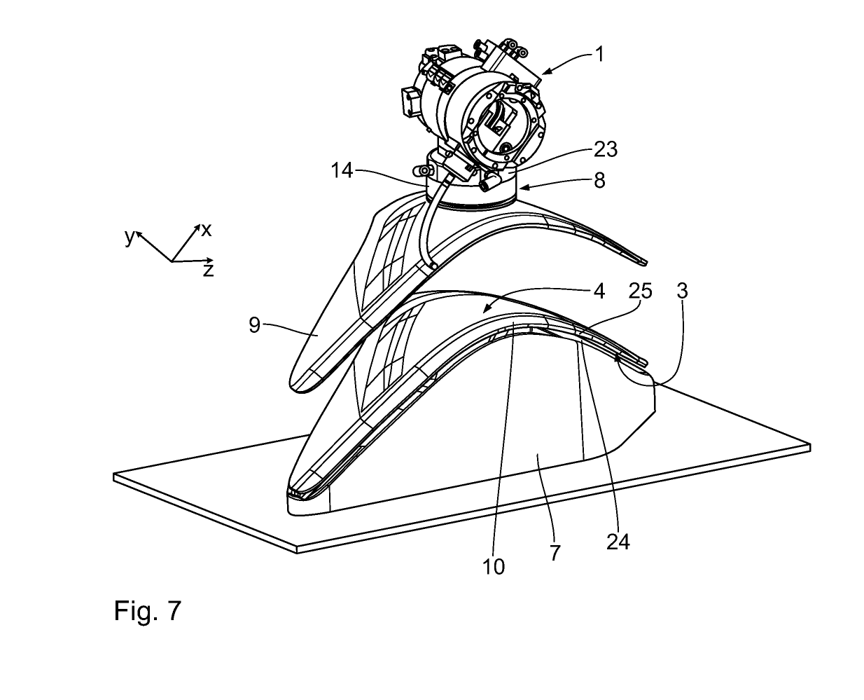

Once the welding has taken place, the beam head 1 docks on the suction valve 14 again and the latter is opened, so the negative pressure between the carrier plate 9 and the upper component 4 is removed. The carrier plate 9 can thus be lifted off the upper component 4—see FIG. 7. The finished structural element of the two components 3, 4 can then be removed from the receiver 7 and the production process for the next structural element can start anew.

1-17. (canceled)

18. A beam-supported joining machine comprising
a beam head for providing a joining beam producing a joining seam between two components,
a receiver for mounting the first component, and
a clamping mechanism for clamping the components, which clamping mechanism has a clamping means adapted to the course of the joining seam to produce a clamping force between the two components at least in the region of the respective joining zone acted upon by the joining beam,
wherein
one of a magnetic and magnetisable strip adapted to the course of the joining seam is provided as the clamping means, which strip, at least in a region of the respective joining zone acted upon by the joining beam, applies a clamping force to the components by means of a control magnet guided with the joining beam which clamping force is due to the magnetic forces acting between the strip and control magnet.

19. A joining machine according to claim 18 configured as a laser transmission welding device.

20. A joining machine according to claim 18, wherein the clamping mechanism is configured to clamp components with a joining seam running three-dimensionally.

21. A joining machine according to claim 18, wherein one of the magnetic and the magnetisable strip has a large number of permanent magnets arranged in a row next to one another, which, with the polarity in the same direction, face the control magnet.

22. A joining machine according to claim 21, wherein the permanent magnets face the control magnet in such a way that a magnetic repulsive force can be produced as the clamping force for the components to be clamped between said control magnet and the permanent magnets.

23. A joining machine according to claim 21, wherein one of the magnetic and the magnetisable strip has a ferromagnetic strip insert that is continuous in the longitudinal direction of the strip to hold the permanent magnets.

24. A joining machine according to claim 18, wherein the control magnet is a solenoid guided with the beam head.

25. A joining machine according to claim 18, wherein the control magnet is a solenoid fastened onto the beam head.

26. A joining machine according to claim 18, wherein the clamping mechanism with one of the magnetic and the magnetisable strip is integrated in a handling device for the second component.

27. A joining machine according to claim 26, wherein the handling device has a carrier plate adapted to the shape of the second component, which carrier plate at least temporarily holds the second component for handling and in the edge region of which is arranged one of the magnetic and the magnetisable strip.

28. A joining machine according to claim 27, wherein the second component can be fastened to the carrier plate by means of negative pressure loading.

29. A joining machine according to claim 28, wherein the carrier plate is configured as a semi-flexible mat.

30. A joining machine according to claim 28, wherein the carrier plate is configured as a silicone mat.

31. A joining machine according to claim 28, wherein the carrier plate is provided with a suction valve, by means of which negative pressure can be applied to the separating plane between the carrier plate and the second component.

32. A joining machine according to claim 31, wherein the suction valve can be closed.

33. A joining machine according to claim 31, wherein the suction valve is simultaneously a docking element for the handling device of the joining machine.

34. A joining machine according to claim 18, wherein the beam head and the handling device are guided on a common manipulator aim.
